(19) United States
(12) Patent Application Publication
(10) Pub. No.: US 2016/0024329 A1
(43) Pub. Date: Jan. 28, 2016

(54) ENERGY CURABLE INKS WITH IMPROVED ADHESION

(71) Applicant: SUN CHEMICAL CORPORATION, Parsippany, NJ (US)

(72) Inventor: Yuemei ZHANG, Ramsey, NJ (US)

(73) Assignee: SUN CHEMICAL CORPORATION, Parsippany, NJ (US)

(21) Appl. No.: 14/379,062

(22) PCT Filed: Mar. 4, 2013
(86) PCT No.: PCT/US2013/028839

§ 371 Date: Aug. 15, 2014

Related U.S. Application Data
(60) Provisional application No. 61/607,086, filed on Mar. 6, 2012.

(51) Int. Cl. C09D 133/08; C08K 3/22; C08K 5/3495

(52) U.S. Cl. CPC C09D 133/08; C08K 5/3495; C08K 3/22; C08K 2003/2241

(57) ABSTRACT

Provided are energy curable inks and coatings that have improved adhesion on flexible substrates, such as non-chemical coated flexible films at fast speed. Also provided are raw material screening methods for quantifying acrylate group concentration, which is used to adjust the ink or coating formula to improve the cure at the surface and bottom and to improve tape adhesion and MEK resistance of energy cured inks and coatings.

### RELATED APPLICATION

Benefit of priority is claimed to U.S. Provisional Application Ser. No. 61/607,086, filed Mar. 6, 2012, entitled “ENERGY CURABLE INKS WITH IMPROVED ADHESION AND A METHOD FOR FORMULATING,” to Yuemei Zhang.

Where permitted, the subject matter of the above-referenced provisional application is incorporated by reference herein in its entirety.

### FIELD OF THE INVENTION

The present invention relates generally to energy curable inks and coatings that exhibit good cure, MEK rub resistance and adhesion to flexible substrates, such as films used for packaging and labeling of commercial articles. Also provided are screening methods of component ingredients for relative acrylate group concentration, which is used to adjust the ink or coating composition to improve cure, tape adhesion and MEK rub resistance of the energy curable inks and coatings.

### BACKGROUND

Flexible films are commonly used in the decorating and/or labeling of commercial articles and consumer goods, such as containers for foods, beverages, cosmetics, and personal care and household care products. Inks and coatings curable using actinic radiation are known in the art (e.g., see U.S. Pat. Nos. 8,371,688; 7,749,573; 6,893,722; and 6,596,407) and can be modified to print on flexible substrates, such as flexible film substrates. Examples of various flexible films include those containing polyethylene terephthalate (PET), biaxially oriented polystyrene (OPS), oriented polypropylene (OPP), oriented nylon, polyvinyl chloride (PVC), polyester (PE), cellulose triacetate (TAC), polycarbonate, polyolefin, acrylonitrile butadiene styrene (ABS), polyacetal and polyvinyl alcohol (PVA). Films containing these polymers typically are non-absorbent and generally fail to form strong bonds with an ink or coating composition applied to the film. Traditional energy curable inks and coatings often fail to exhibit sufficient adhesion to these flexible substrates, such as the films used for decorating or labeling modern container designs. Consequently, such substrates often need to be surface treated in order for an ink or coating to properly adhere (e.g., see U.S. Pat. Nos. 8,236,385; 5,849,368; 5,264,989 and 4,724,508).

Accordingly, a need exists for energy curable ink and coating compositions that exhibit good adhesion on flexible substrates, such as flexible films, including non-absorbent hydrophobic substrates, without the need for surface treating the substrates.

### SUMMARY OF THE INVENTION

Provided are energy curable inks and coatings and methods for the formulation of the inks and coatings for use in the preparation of printed flexible substrates, such as flexible films, for use in the decorating and/or labeling of commercial articles and other applications. The energy curable inks provided herein exhibit good adhesion to the flexible substrates and reduce or eliminate the need to surface-treat the substrates in order for the ink or coating to adhere. Also provided are methods for formulating energy curable inks to achieve enhanced adhesion on flexible film substrates. The methods include selecting components of the ink or coating composition based on their content of acrylate groups, so that the final ink or coating composition has an overall relative acrylate group concentration>4.0.

The energy curable printing ink or coating compositions provided herein include a monomer containing one or more acrylate groups or an oligomer containing one or more acrylate groups or a combination of monomers and oligomers containing one or more acrylates groups, where the composition has an acrylate group concentration>4.0. In some instances, the acrylate group concentration can be >4.25, or >4.5, or >4.75, or >5.0, or >5.25, or >5.5, or >5.75, or >6.0.

Any monomer or oligomer having one or more acrylate groups can be selected and used as a component of the energy curable printing ink or coating compositions provided herein. In some instances, monomers or oligomers having a higher density of acrylate groups (relative to the overall molecular weight of the monomer or oligomer) are selected. Exemplary monomers include propoxylated neopentyl glycol diacrylate (2PO-NPGDA), 1,6-hexanediol diacrylate (HDODA), hexanediol diacrylate (HDDA), dipentaerythritol hexaacrylate (DPHA), ethoxylated hexanediol diacrylate (EOHDDA), trimethylolpropane triacrylate (TMPTA), ethoxylated trimethylolpropane triacrylate (EOTMPTA), dipropylene glycol diacrylate (DPGDA) and combinations thereof. Exemplary oligomers include acidic acrylates, epoxy acrylates, polyester acrylates, ethoxylated acrylates, unsaturated polyesters, polyamide acrylates, polyimide acrylates and urethane acrylates and combinations thereof. The monomer can be present in an amount of up to 75 wt % based on the weight of the composition. The oligomer can be present in an amount of up to 50 wt % based on the weight of the composition. The energy curable printing ink or coating can include only monomer. The energy curable printing ink or coating can include only oligomer. The energy curable printing ink or coating composition can include a combination of monomer and oligomer. In some instances, when a monomer and an oligomer are present in the energy curable printing ink or coating composition, the ratio of momomer:oligomer is X:Y, where X is selected from among 0.1 to 100 and Y is selected from among 0.1 to 10.

The energy curable printing ink or coating compositions provided herein can include other components, such as acidic or amine modified adhesion promoters, pigments or dyes or a combination thereof, one or more photoinitiators, resin, oil, talc, pigment dispersant, gelled vehicle, a polyvinylethyl ether or poly(n-butyl)acrylate, waxes, ammonia, a defoamer, a stabilizer, a silicone and plasticizers, alone or in any combination. The ink or coating composition can be formulated to have a viscosity suitable for deposition by any deposition process known in the art. Exemplary deposition processes include flexographic, gravure, roller coating, cascade coating, curtain coating, slot coating, wire bound bar and digital deposition processes. The energy curable printing ink or coating can be cured using any appropriate energy source. Exemplary energy sources include actinic radiation, such as radiation having a wavelength in the ultraviolet or visible or infrared region of the spectrum; accelerated particles, such as electron beam radiation; or thermal, such as heat. Examples of suitable sources of actinic radiation include, but are not limited to, mercury lamps, xenon lamps, carbon arc lamps, tungsten filament lamps, lasers, light emitting diodes, sunlight, and electron beam emitters and combinations thereof.

Also provided are methods of formulating an energy curable printing ink or coating composition, where the method includes as steps selecting one or more monomers containing an acrylate group or one or more oligomers containing an acrylate group or a combination thereof, and incorporating the monomer(s) or oligomer(s) or combination thereof in the composition an amount to yield an ink or coating composition having a relative acrylate group concentration >4.0, or >4.25, or >4.5, or >4.75, or >5.0, or >5.25, or >5.5, or >5.75 or >6.0. The inks and coatings can be deposited on any substrate, particular flexible substrate, including flexible films. The inventive inks and coatings do not require pre-treatment of the substrates for adherence of the ink or coating. The ink or coating can be formulated to have a viscosity suitable for deposition by any desired deposition process, such as flexographic, gravure, roller coating, cascade coating, curtain coating, slot coating, wire bound bar and digital processes. A preferred deposition process is flexographic, where the ink or coating can be formulated to have a viscosity of 2,000 cP or less, or 1,000 cP or less, or 500 cP or less, or 200 cP or less when measured at 25° C. at a shear rate of 100 sec⁻¹.

Once deposited on a substrate, the ink or coating can be cured using any suitable energy source, such as mercury lamps, xenon lamps, carbon arc lamps, tungsten filament lamps, lasers, light emitting diodes, sunlight, and electron beam emitters or combinations thereof. In some methods, the ink or coating is curable by any one of UV, LED, H-UV and EB radiation or a combination thereof, particularly by using UV radiation. The methods result in a printed article that includes the cured ink or coating provided herein. The cured ink or coating exhibits improved adhesion and rub resistance compared to prior art comparative inks that have a relative acrylate group concentration <4.0.

### DETAILED DESCRIPTION OF THE INVENTION

It is to be understood that the foregoing general description and the following detailed description are exemplary and explanatory only and are not restrictive of any subject matter claimed.

The section headings used herein are for organizational purposes only and are not to be construed as limiting the subject matter described.

### I. DEFINITIONS

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose.

In this application, the use of the singular includes the plural unless specifically stated otherwise. As used herein, the singular forms “a”, “an” and “the” are intended to include the plural forms as well, unless the context clearly indicates otherwise.

In this application, the use of “or” means “and/or” unless stated otherwise.

As used herein, the terms “comprises” and/or “comprising,” specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “composed”, “comprised” or variants thereof are used in either the detailed description or the claims, such terms are intended to be inclusive in a manner similar to the term “comprising.”

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

As used herein, “monomer” refers to a material having a viscosity less than that of an oligomer and a relatively low molecular weight (i.e., having a molecular weight less than about 500 g/mole) and containing one or more polymerizable groups, which are capable of polymerizing and combining with other monomers or oligomers to form other oligomers or polymers. A monomer can have a viscosity of 150 cP or less measured at 25° C. at a shear rate of about 4 to 20 sec⁻¹ with a Brookfield viscometer. A monomer can be used to modulate the viscosity of an oligomer or of an ink or coating composition.

As used herein, “oligomer” refers to a material having a viscosity greater than that of a monomer and a relatively intermediate molecular weight (i.e., having a molecular weight greater than about 500 g/mole but generally less than 100,000 g/mole) having one or more radiation polymerizable groups, which are capable of polymerizing and combining with monomers or oligomers to form other oligomers or polymers. The number average molecular weight of the oligomer is not particularly limited and can be, for example, between about 500-10,000 g/mole. Molecular weight can be selected to achieve the desired viscosity, modulus, solvent resistance and other important properties. Oligomer molecular weight and its distribution can be determined by gel permeation chromatography. An oligomer can be used to modulate the viscosity of an ink or coating composition.

As used herein, “polymer” refers to a high viscosity molecule comprising a substructure formed from one or more monomeric, oligomeric, and/or polymeric constituents polymerized or cross-linked together. The monomer and/or oligomer units can be regularly or irregularly arranged and a portion of the polymer chemical structure can include repeating units.

As used herein, the term “molecular weight” means number average molecular weight, Mₙ, unless expressly noted otherwise.

As used herein, “[C═C]” refers to concentration of C═C bonds.

As used herein, “concentration of acrylate group” or “acrylate group concentration” refers to the mole amount of acrylate group

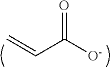

in a unit volume (m³) of ink or coating or resin system. It can be expressed using the equation below:

$$[ C = C ] = \frac{Average real fuctionality}{Average {M}_{n} / ( 1000 * Density )} \\ [ C = C ] , concentration of acrylic functional group , mol . {m}^{- 3}$$

$${M}_{n} , Number average molecular weight , g . {mol}^{- 1}$$

$$Density \text{:} kg \text{/} {m}^{3}$$

As used herein, “relative acrylate group concentration” refers to acrylate concentration as measured, such as values obtained for acrylate group content based on FTIR measurements, or values calculated using FTIR measurements.

As used herein, “multifunctional” means having two or more functional groups. A multifunctional monomer, e.g., can be a di-functional, tri- functional, tetra- functional or have a higher number of functional groups. For example, a multifunctional acrylate includes diacrylates, triacrylates and tetraacrylates.

As used herein, “setting” refers to ink film formation and apparent drying of the ink. Although the ink chemically may not be dried, the ink is set and exhibits rub resistance.

As used herein, “cure” or “curing” refers to a process that leads to polymerizing, hardening and/or cross-linking of monomer and/or oligomer units to form a polymer. Curing can occur via any polymerization mechanism, including, e.g., free radical routes, and/or in which polymerization is photoinitiated, and can include the use of a radiation sensitive photoinitiator.

As used herein, the terms “curable ink” and “curable coating” refer to an ability of an ink or coating to polymerize, harden, and/or cross-link in response to suitable curing stimulus such actinic radiation such as ultraviolet (UV) energy, infrared (IR) energy, light emitting diode (LED) energy, electron beam (EB) energy, heat energy, or other source of energy, with appropriate initiators included in the resin, ink or coating if required. A curable ink or coating typically is liquid at 25° C. prior to curing. A curable ink or curable coating can be used to print a substrate, forming a film of printed ink or coating. The film of curable ink or coating then is cured, hardening, polymerizing and/or cross-linking the ink or coating to form a cured ink or coating.

As used herein, the term “cured ink” or “cured coating” refers to a curable ink or coating that has been polymerized. In a cured ink or coating, the curable components of a curable ink or curable coating react upon curing to form a polymerized or cross-linked network. On curing, the liquid or fluid curable ink or coating cross-links, polymerizes and/or hardens to form a film of cured ink or cured coating. When the curable ink or curable coating cures from a liquid state to a solid state, the curable monomers and/or oligomers form (1) chemical bonds, (2) mechanical bonds, or (3) a combination of a chemical and mechanical bonds.

As used herein, “improved rub resistance” refers to achieving a rub resistance of a printed ink in a certain amount of time after printing that is better that the rub resistance achieved with a comparable control printed ink in the same amount of time. As an example, inks exhibiting improved rub resistance exhibit improved processability, in which the printed substrate can be subjected to further processing without detrimental effect to the printed ink. In some instances, an ink demonstrating improved rub resistance has a rub resistance in 15 minutes or less that is equal to the rub resistance achieved in a standard ink after 1 hour.

As used herein, the term “bottom curing” refers to curing of the ink or coating at the interface between the substrate and the ink or coating.

As used herein, “radiation curable” refers to curing in response to exposure to suitable radiation such as ultra violet (UV) radiation, light emitting diode (LED) energy, infrared or electron beam radiation. The term “radiation curable” is intended to cover all forms of curing upon exposure to a radiation source. The energy source used to initiate crosslinking of the radiation-curable components of the composition can be actinic, such as radiation having a wavelength in the ultraviolet or visible region of the spectrum; accelerated particles, such as electron beam radiation; or thermal, such as heat or infrared radiation. Examples of suitable sources of actinic radiation include mercury lamps, xenon lamps, carbon arc lamps, tungsten filament lamps, lasers, light emitting diodes, sunlight, and electron beam emitters. The curing light can be shuttered, filtered or focused.

As used herein, “adhesion promoter” refers to any material that promotes adhesion of two surfaces. In some instances, the material can include two or more functional groups that can be used to crosslink two or more monomers or oligomers. The adhesion promoter can include acidic or amine functionalities.

Throughout this disclosure, all parts and percentages are by weight (wt % or mass % based on the total weight; parts by weight) and all temperatures are in ° C., unless otherwise indicated.

### II. INKS AND COATINGS FOR FLEXIBLE SUBSTRATES

Inks and coatings for flexible substrates, such as packaging films, are known in the art. Shrinkage and cracking of such coatings and inks are a common problem. For example, Stansbury and Ge describe photopolymerization shrinkage and stress in resins and composites (RADTECH REPORT MAY/JUNE 2003, pages 56-62). Methods for measuring shrinkage and cure are discussed in the art (see, e.g., Salahuddin and Shehata, Reduction of polymerization shrinkage in methyl methacrylate-montmorillonite composites, Materials Letters 52(4-5): 289-294 (February 2002); Lin-Gibson et al., Polymerization shrinkage measurements of photocross-linked dimethacrylate films, Polymer Preprints 47(1) 500 2006); Francis et al., Development and measurement of stress in polymer coatings, J. Materials Science 37: 4717-4731 (2002); Sukhareva et al., Thermophysical characteristics of polymer coatings, Journal of Engineering Physics and Thermophysics 9(2): 147-150 (1965); Stolov et al., Simultaneous Measurement of Polymerization Kinetics and Stress Development in Radiation-Cured Coatings: A New Experimental Approach and Relationship between the Degree of Conversion and Stress, Macromolecules 33(19): 6970-6976 (2000); Smirnova et al., Measuring the shrinkage of UV-hardenable composites based on acrylates and diacrylates, J. Opt. Technol. 73: 352-355 (2006); Miezeiwski et al., U.S. Pat. No. 7,232,851; and Zhang et al., Modeling and Measuring UV Cure Kinetics of Thick Dimethacrylate Samples, Macromolecules 42(1): 203-210 (2009).

Polyethylene (PE) is one of the most popular substrates for packaging applications. Different from polyethylene terephthalate (PET) or oriented polypropylene (OPP) films, PE has relatively lower tensile strength and is more stretchable. The Applicant discovered a novel method for formulating energy curable inks to achieve the best adhesion on flexible substrates, including PE film and other low tensile strength films.

In order to achieve adhesion on flexible films, the prior art teaches that formulators generally try to use low functionality monomers and oligomers to decrease the degree of crosslinking and shrinkage, and thereby improve the flexibility of the cured ink layer (see, e.g., Arceneaux and Willard, RadTech Printer's Guide (2007) page 6.

In the present application, however, it was surprisingly found that increasing the relative concentration of acrylate group [C═C] in the formula improved ink adhesion on flexible substrates, such as low tensile strength flexible films such as PE and PVC, as well as high tensile strength films, optionally with a primer or a low crystalline density co-extruded film on the print side of the film. Exemplary substrates include coated and non-coated polymeric substrates (high density polyethylene (HDPE), low-density polyethylene (LDPE), medium-density polyethylene (MDPE), biaxially-oriented polypropylenes ((BO)PPs), polyvinyl chlorides (PVCs), glycol-modified polyethylene terephthalates (PET(G)s), etc.); paper and board substrates; as well as any other substrates utilized in lithographic and/or flexographic printing, and/or other printing technology. An example of another film substrate would be plastic board that has low glass transition (Tg) or crystalline density. In addition, it was found that the inventive inks and coatings containing a higher relative concentration of acrylate group monomers/oligomers provided herein, such as an acrylate group concentration >4.0, also maintains adhesion at faster line speed while other commercial inks that have a relative acrylate group concentration <4.0 lose adhesion at faster line speed.

Functionality is usually a parameter relied upon in academic and industrial fields to predict cure properties, and concentration of acrylate group is rarely mentioned in UV cure technology. It was during the formulation of the energy curable inks and coatings as described herein that the concept of concentration of acrylate group as a method of formulating energy curable inks with improved adhesion and/or improved cure and/or improved resistance properties was developed by the Applicant.

Even though some higher functionality monomers/oligomers do have higher [C═C], it is not always the case that higher functionality always results in higher [C═C]. The Mₙ of monomers and oligomers can vary from tens to tens of thousands for different acrylate materials with the same functionality. Therefore, functionality alone is insufficient to predict ink or coating curing and adhesion properties. In addition, the information regarding functionality given on technical data sheets by suppliers is often a theoretical functionality and the actual functionality can be lower and usually is lower.

Even though concentration of acrylate group is rarely mentioned in UV cure academic and technical publications, a similar concept such as weight per acrylate group has been presented in some papers. It is commonly believed in the prior art that increasing the weight per acrylate group increases flexibility and adhesion. This is contrary to what is described herein. The inventive inks and coating provided herein demonstrate that decreasing the weight per acrylate (formulating to have high acrylate group concentration per unit volume or per monomer or oligomer) increases flexibility and adhesion.

The inks and coatings provided herein include more acrylate groups in a unit volume and exhibit improved adhesion. This is counterintuitive to existing knowledge in the UV curing industry since the art teaches that a higher concentration of acrylate group would generally result in a higher degree of crosslinking, more shrinkage, and possibly higher Tg, which would combine to make the cured system more rigid resulting in worse adhesion, particularly to flexible substrates. Despite the differences between pigmented inks and non-pigmented coatings, the present invention encompasses both inks and coatings. While not wishing to be bound to any specific theory, applicant believes that pigmented UV ink systems are often very different from UV coatings and other applications. First, ink films are typically much thinner than coatings and other systems, which makes them more flexible. Second, inks usually contain a higher level of dry pigment and other dry additives, which can decrease the film shrinkage and crosslinking. Third, pigment and photoinitiator can absorb/diffract a significant amount of light, therefore UV cure kinetics is highly depth dependent. Accordingly, monomer/oligomer with higher concentration of acrylate groups helps with adhesion of inks and coatings possibly due to improvement in bottom curing. In another words, a reason for poor adhesion in prior art inks could be poor bottom curing instead of poor flexibility.

The general kinetics and mechanism of free radical chain polymerization of UV cure is known in the art. The classic textbook equation has been described in Odian's book, Principles Of Polymerization, as shown below, is widely cited in many academic publications:

$$R = - \frac{d [ M ]}{d t} = {{k}_{p} ( \frac{4.6 φ ɛ l}{{k}_{t}} )}^{0.5} {{I}_{i}^{0.5} [ PI ]}^{0.5} [ M ]$$

where R is cure rate, kₚ and kₜ are rate constants of propagation and termination, Φ is quantum yield of initiation, c is the extinction coefficient of initiator, [M] is the concentration of monomer, [PI] is the concentration of photo initiator, I is the thickness of the sample, Iᵢ is the incident light intensity.

This equation is known to those skilled in the art and the general rule for UV curing from this equation is that increasing light intensity, concentration of monomers, and concentration of photoinitiator concentration would increase cure rate and hence increase the cure extent and crosslinking of the cured film at a given speed and exposure time. Not many people may be familiar with the assumptions behind this equation. One of the assumptions is that that the incident light intensity is almost the same as the transmitted intensity. Most inks, especially high opacity white and non-transparent dark color inks, do not satisfy this assumption. Pigments and photoinitiators in these inks can have either a strong absorption or diffraction or both in the wavelength range of UV radiation. Therefore transmitted light intensity, or light that reaches the ink bottom layers, can be much weaker than light that reaches ink surface layers. This results in a depth dependent cured kinetics as described in some academic literature, (e.g., see Zhang et al., Macromolecules 42(1): 203-210 (2009). The cure at surface layers is typically much faster and more complete than the cure as bottom layers. At a given exposure time, which is often determined by press line speed for the printing ink industry, it is quite possible that the surface layers are already cured to >70% conversion while the bottom layers are only cured to <30%.

There are many ways that to improve cure efficiency. One way is to change the radiation source so that it emits higher light intensity or emits light at longer wavelengths that can penetrate deeper. The radiation source, however, is typically determined by the end users and rarely can be changed, making this approach impractical. Another approach is to slow down the line speed, which is not economically efficient. Another approach is to select photoinitiators that have absorption at longer wavelengths where light can penetrate more into the bottom of the ink layer. This approach has not been found to result in satisfactory cure.

### III. INVENTIVE INK AND COATING COMPOSITIONS

Applicant surprisingly has found that increasing the total concentration of acrylate group in the energy curable ink or coating formula effectively improves ink adhesion on flexible substrates, especially on flexible films, such as low tensile strength and high tensile strength films. A reason for the better adhesion can be the improvement of bottom curing or crosslink formation or a combination thereof, which can be achieved by using acrylate monomer/oligomers with a higher concentration of acrylate group. The Applicant has determined that it is neither the concentration of monomer nor functionality alone that determines the bottom curing and adhesion. Instead, the Applicant has determined that it is the concentration of acrylate group of the raw material that has an overwhelming effect on bottom curing, adhesion and many other functional properties.

The inventive energy curable inks and coatings provided herein exhibit an extremely high concentration of acrylate group, generally having a relative acrylate group concentration >4.0. One improvement of the inks and coatings of the present invention is in the superior adhesion/cure on flexible substrates, such as transparent and opaque white polyethylene or high density polyethylene [(HD)PE] film substrates, at elevated printing speeds. This enables faster printing line speed. Another improvement of the inks and coating provided herein having a relative acrylate group concentration >4.0 is their resistance properties, e.g., as expressed as MEK rub resistance.

The energy curable inks and coatings provided herein can be cured using any form of actinic radiation. Exemplary of actinic radiation forms that can be used to cure the inks and coatings provided herein include ultraviolet (UV) energy, including UVA and UVB, electron beam (EB) curing (with or without photoinitiators), infrared (IR) or combinations thereof, alone or in combination with cationic curing. Any energy source that can produce the actinic radiation can be used to cure the ink or coating. Exemplary light sources include high intensity mercury arc UV lamps, H mercury lamps, low pressure mercury vapor lamps, xenon lamps, carbon arc lamps, lasers, UV light emitting diodes (LEDs), sunlight and electron beam emitters. Incident or intentional application of heat, such as via IR irradiation or the heat given off by the actinic energy source, can be used in conjunction with the actinic radiation.

As shown in the Examples, lab tests demonstrate that the inventive inks and coatings having a relative acrylate group concentration >4.0 maintained 100% adhesion to the substrate when cured using a 200 watt Hg UV lamp at a speed of 150 fpm (feet per minute), while all of the commercial (comparative prior art) inks having a relative acrylate concentration <4.0 tested failed the adhesion test, exhibiting 100% loss of adhesion (expressed as 100% peel off). In addition, press trial test prints of the inventive inks having an acrylate concentration >4.0 cured at the advanced speed of 240 FPM using a 300 watt Hg UV lamp maintained 100% adhesion, while commercially available comparative prior art inks having an acrylate concentration <4.0 failed with 0% adhesion.

A. Monomers and/or Oligomers Containing an Acrylate Group

The energy curable inks and coatings provided herein contain a reactive monomer or oligomer or combination thereof, where the monomer or oligomer contains an acrylate group. The level of functionality of the monomers and/or oligomers can vary, and monofunctional or multifunctional acrylates or combinations thereof can be selected. Multifunctional acrylates can be selected from among diacrylates, triacrylates, tetra-acrylates, pentaacrylates, hexaacrylates and higher functionalities. In general, the monomer and/or oligomers are selected so that the total relative acrylate group concentration of the ink or coating is >4.0. For example, a lower quantity of a multifunctional acrylate compound could be replaced with a higher quantity of monofunctional acrylate compound and still result in a composition having similar acrylate concentration. Compounds having a high density of acrylate functionality (acrylate group concentration per molecular weight of the compound) are preferred components of the inks and coatings, and can be used alone or in combination with other acrylate group-containing components. Particularly preferred components are trimethylolpropane triacrylate (TMPTA) and dipentaerythritol hexaacrylate (DPHA).

Examples of difunctional monomer/oligomer that can be included in the inks and coating compositions include alkoxylated aliphatic diacrylate, alkoxylated neopentyl glycol diacrylate, 1,4-butanediol diacrylate, 1,3-butylene glycol diacrylate, cyclohexane dimethanol diacrylate, diethylene glycol diacrylate, dipropylene glycol diacrylate, 1,6-hexanediol diacrylate, neopentyl glycol diacrylate, polyester diacrylate, polyethylene glycol (200) diacrylate, polyethylene glycol (400) diacrylate, polyethylene glycol (600) diacrylate, propoxylated neopentyl glycol diacrylate, propoxylated (2) neopentyl glycol diacrylate, tetraethylene glycol diacrylate, tricyclodecane dimethanol diacrylate, triethylene glycol diacrylate and tripropylene glycol diacrylate and combinations thereof.

Examples of trifunctional monomer/oligomer that can be included in the inks and coating compositions include ethoxylated (3) trimethylolpropane triacrylate, ethoxylated (6) trimethylolpropane triacrylate, ethoxylated (9) trimethylolpropane triacrylate, ethoxylated (15) trimethylolpropane triacrylate, ethoxylated(20) trimethylolpropane triacrylate, pentaerythritol triacrylate, propoxylated (3) glyceryl triacrylate, propoxylated (3) glyceryl triacrylate, propoxylated (5.5) glyceryl triacrylate, propoxylated (3) trimethylolpropane triacrylate, propoxylated (6) trimethylolpropane triacrylate, trimethylolpropane triacrylate and tris-(2-hydroxyethyl)-isocyanurate triacrylate and combinations thereof.

Examples of tetrafunctional and pentafunctional monomer/oligomer that can be included in the inks and coating compositions include di-(trimethylolpropane)-tetraacrylate, ethoxylated (4) pentaerythritol tetraacrylate, polyester tetraacrylate, dipentaerythritol pentaacrylate, pentaacrylate ester and pentaerythritol tetraacrylate and combinations thereof.

Preferred exemplary reactive monomers include ethoxylated 1,6-hexanediol diacrylate (EOHDDA), 1,6-hexanediol diacrylate (HDDA), trimethylolpropane triacrylate (TMPTA), dipentaerythritol hexaacrylate (DPHA) and ethoxylated trimethylolpropane triacrylate (EOTMPTA). Preferred exemplary oligomers with different levels of functionality include epoxy acrylates, polyester acrylates, ethoxylated acrylates, unsaturated polyesters, polyamide acrylates, polyimide acrylates, and urethane acrylates and different types of methyl acrylates.

The [C═C] values for exemplary materials are provided in Table 1.

TABLE 1
[C═C] values of exemplary monomers/oligomers.

| | [C═C] |
|---|---|
| Material | (Test Method 1A) |
| TMPTA | 6.3 |
| Sartomer CN 147 | 4.5 |
| EO-TMPTA | 4.4 |
| DPHA | 7.5 |
| ¹Ebecryl 871 | 3.88 |
| ²Sartomer CN 147 | 4.5 |
| HDODA | 4.96 |
| 2PO-NPGDA | 2.74 |
| 2EO-HDODA | 3.68 |
| DPGDA | 4.9 |
| HDDA | 4.9 |

¹Ebecryl 871 is a polyester tetraacrylate.
²Sartomer CN 147 is an acidic acrylate oligomer.

In some applications, the amount of monomers or oligomers or a combination thereof in the ink or coating composition can be greater than 10 wt %, or greater than 15 wt %, or greater than 20 wt %, or greater than 25 wt %, or greater than 30 wt %, or greater than 35 wt %, or greater than 40 wt %, or greater than 45 wt %, or greater than 50 wt %, or greater than 55 wt %, or greater than 60 wt %, or greater than 65 wt %, or greater than 70 wt %, or greater than 75 wt %, or greater than 80 wt %, or greater than 85 wt %, or greater than 90 wt %, based on the total weight of the ink or coating composition. In some applications, acrylate-containing monomers or oligomers or a combination thereof are present in an amount in the range or from 10 wt % to 95 wt %, or of from 20 w t% to 95 wt %, or 25 wt % to 90 wt %, or 30 wt % to 85 wt %, or 35 w t% to 80 wt %, or 40 wt % to 75 wt %, or 25 wt % to 75 wt %, or 30 wt % to 60 wt %.

In some applications, an acrylate-containing monomer or an acrylate-containing oligomer, each independently, can be present in an amount independently selected from among 10 wt %, 10.5 wt %, 11 wt %, 11.5 wt %, 12 wt %, 12.5 wt %, 13 wt %, 13.5 wt %, 14 wt %, 14.5 wt %, 15 wt %, 15.5 wt %, 16 wt %, 16.5 wt %, 17 wt %, 17.5 wt %, 18 wt %, 18.5 wt %, 19 wt %, 19.5 wt %, 20 wt %, 20.5 wt %, 21 wt %, 21.5 wt %, 22 wt %, 22.5 wt %, 23 wt %, 23.5 wt %, 24 wt %, 24.5 wt %, 25 wt %, 25.5 wt %, 26 wt %, 26.5 wt %, 27 wt %, 27.5 wt %, 28 wt %, 28.5 wt %, 29 wt %, 29.5 wt %, 30 wt %, 30.5 wt %, 31 wt %, 31.5 wt %, 32 wt %, 32.5 wt %, 33 wt %, 33.5 wt %, 34 wt %, 34.5 wt %, 35 wt %, 35.5 wt %, 36 wt %, 36.5 wt %, 37 wt %, 37.5 wt %, 38 wt %, 38.5 wt %, 39 wt %, 39.5 wt %, 40 wt %, 40.5 wt %, 41 wt %, 41.5 wt %, 42 wt %, 42.5 wt %, 43 wt %, 43.5 wt %, 44 wt %, 44.5 wt %, 45 wt %, 45.5 wt %, 46 wt %, 46.5 wt %, 47 wt %, 47.5 wt %, 48 wt %, 48.5 wt %, 49 wt %, 49.5 wt %, 50 wt %, 50.5 wt %, 51 wt %, 51.5 wt %, 52 wt %, 52.5 wt %, 53 wt %, 53.5 wt %, 54 wt %, 54.5 wt %, 55 wt %, 55.5 wt %, 56 wt %, 56.5 wt %, 57 wt %, 57.5 wt %, 58 wt %, 58.5 wt %, 59 wt %, 59.5 wt %, 60 wt %, 60.5 wt %, 61 wt %, 61.5 wt %, 62 wt %, 62.5 wt %, 63 wt %, 63.5 wt %, 64 wt %, 64.5 wt %, 65 wt %, 65.5 wt %, 66 wt %, 66.5 wt %, 67 wt %, 67.5 wt %, 68 wt %, 68.5 wt %, 69 wt %, 69.5 wt %, 70 wt %, 70.5 wt %, 71 wt %, 71.5 wt %, 72 wt %, 72.5 wt %, 73 wt %, 73.5 wt %, 74 wt %, 74.5 wt %, 75 wt %, 75.5 wt %, 76 wt %, 76.5 wt %, 77 wt %, 77.5 wt %, 78 wt %, 78.5 wt %, 79 wt %, 79.5 wt %, 80 wt %, 80.5 wt %, 81 wt %, 81.5 wt %, 82 wt %, 82.5 wt %, 83 wt %, 83.5 wt %, 84 wt %, 84.5 wt %, 85 wt %, 85.5 wt %, 86 wt %, 86.5 wt %, 87 wt %, 87.5 wt %, 88 wt %, 88.5 wt %, 89 wt %, 89.5 wt %, 90 wt %, 90.5 wt %, 91 wt %, 91.5 wt %, 92 wt %, 92.5 wt %, 93 wt %, 93.5 wt %, 94 wt %, 94.5 wt %, 95 wt %, 95.5 wt %, 96 wt %, 96.5 wt %, 97 wt %, 97.5 wt %, 98 wt %, 98.5 wt %, 99 wt % or 99.5 wt % by weight of the ink or coating composition.

The energy curable printing ink or coating can include monomer and no oligomer. The energy curable printing ink or coating can include oligomer and no monomer. The energy curable printing ink or coating composition can include a combination of monomer and oligomer. In some instances, when a monomer and an oligomer are present in the energy curable printing ink or coating composition, the ratio of momomer:oligomer is X:Y, where X is selected from among 0.1 to 100 and Y is selected from among 0.1 to 10.

The inks and coatings provided herein have a relative acrylate group concentration >4.0. In some applications, the inks and coatings provided herein have a relative acrylate group concentration >4.5 or >5.0 or >5.5 or >6.0 or >6.5. For example, in the case of opaque inks, a relative acrylate group concentration >4.5 or >5.0 is preferred. In some instances, the inks and coatings provided herein have a relative acrylate group concentration of from 4.0 to 7.5, or from 4.25 to 7.25, or from 4.5 to 7.0, or from 4.75 to 6.75, or from 5.0 to 6.5, or from 4.0 to 6.0. In some instances, the inks and coatings provided herein have a relative acrylate group concentration of 4.0, 4.05, 4.1, 4.15, 4.2, 4,25, 4.3, 4.35, 4.4, 4.45, 4.5, 4.55, 4.6, 4.65, 4.7, 4.75, 4.8, 4.85, 4.9, 4.95, 5.0, 5.05, 5.1, 5.15, 5.2, 5.25, 5.3, 5.35, 5.4, 5.45, 5.5, 5.55, 5.6, 5.65, 5.7, 5.75, 5.8, 5.85, 5.9, 5.95, 6.0, 6.05, 6.1, 6.15, 6.2, 6.25, 6.3, 6.35, 6.4, 6.45, 6.5, 6.55, 6.6, 6.65, 6.7, 6.75, 6.8, 6.85, 6.9, 6.95, 7.0, 7.05, 7.1, 7.15, 7.2, 7.25, 7.3, 7.35, 7.4, 7.45 or 7.5.

### B. Pigments and Dyes

The inks and coatings provided herein can be clear or transparent or colorless or translucent or pearlescent or opaque or can include a pigment or dye or combination thereof to have a selected color and/or opacity. The pigments and dyes can be organic or inorganic. Exemplary inorganic pigments include, but are not limited to, carbon black and titanium dioxide, while suitable organic pigments include, but are not limited to, phthalocyanines, antrhraquinones, perylenes, carbozoles, monoazo- and disazobenzimidazolones, isoindolinones, mono-azonaphthols, diarylidepyrazolones, rhodamines, indigoids, quinacridones, diazo-pyranthrones, dinitranilines, pyrazolones, dianisidines, pyranthrones, tetrachloroiso-indolinones, dioxazines, monoazoacrylides, and anthrapyrimidines. It will be recognized by those skilled in the art that organic pigments are differently shaded, or even have different colors, depending on the functional groups attached to the main molecule.

Commercial examples of useful organic pigments include, but are not limited to, those described in The Color Index, Vols. 1-8, Society of Dyers and Colorists, Yorkshire, England having the designations Pigment Blue 1, Pigment Blue 15, Pigment Blue 15:1, Pigment Blue 15:2, Pigment Blue 15:3, Pigment Blue 15:4, Pigment Blue 15:6, Pigment Blue 16, Pigment Blue 24, and Pigment Blue 60 (blue pigments); Pigment Brown 5, Pigment Brown 23, and Pigment Brown 25 (brown pigments); Pigment Yellow 3, Pigment Yellow 14, Pigment Yellow 16, Pigment Yellow 17, Pigment Yellow 24, Pigment Yellow 65, Pigment Yellow 73, Pigment Yellow 74, Pigment Yellow 83, Pigment Yellow 95, Pigment Yellow 97, Pigment Yellow 108, Pigment Yellow 109, Pigment Yellow 110, Pigment Yellow 113, Pigment Yellow 128, Pigment Yellow 129, Pigment Yellow 138, Pigment Yellow 139, Pigment Yellow 150, Pigment Yellow 154, Pigment Yellow 156, and Pigment Yellow 175 (yellow pigments); Pigment Green 1, Pigment Green 7, Pigment Green 10, and Pigment Green 36 (green pigments); Pigment Orange 5, Pigment Orange 15, Pigment Orange 16, Pigment Orange 31, Pigment Orange 34, Pigment Orange 36, Pigment Orange 43, Pigment Orange 48, Pigment Orange 51, Pigment Orange 60, and Pigment Orange 61 (orange pigments); Pigment Red 4, Pigment Red 5, Pigment Red 7, Pigment Red 9, Pigment Red 22, Pigment Red 23, Pigment Red 48, Pigment Red 48:2, Pigment Red 49, Pigment Red 112, Pigment Red 122, Pigment Red 123, Pigment Red 149, Pigment Red 166, Pigment Red 168, Pigment Red 170, Pigment Red 177, Pigment Red 179, Pigment Red 190, Pigment Red 202, Pigment Red 206, Pigment Red 207, and Pigment Red 224 (red pigments); Pigment Violet 19, Pigment Violet 23, Pigment Violet 37, Pigment Violet 32, and Pigment Violet 42 (violet pigments); and Pigment Black 6 or 7 (black pigments).

In addition to or in place of visible pigments or dyes, the inks and coatings provided herein can contain pigments or dyes that are UV fluorophores that are excited in the UV range and emit light at a higher wavelength (typically 400 nm and above). Examples of UV fluorophores include but are not limited to materials from the coumarin, benzoxazole, rhodamine, napthalimide, perylene, benzanthrones, benzoxanthones or benzothiaxanthones families. The addition of a UV fluorophore (such as an optical brightener for instance) can help maintain maximum visible light transmission or can alter the color of an under-printed ink.

For clear coatings, pigments or dyes that act as optical brighteners or UV fluorophores can be included. In some applications, no pigment or dye is included in the coatings. When present, the amount of pigment or dye generally is in the range of 0.1 wt % to 75 wt % based on the weight of the composition. For opaque inks, the amount of colorant, pigment or dye can be in the range of from 25 wt % to 85 wt %.

### C. Photoinitiators

The energy curable inks and coatings provided herein can contain one or more photoinitiators. Examples of photoinitiators that can be included in the ink and coating compositions include, but are not limited to, benzoin ethers, such as benzoin methyl ether, benzoin ethyl ether, and benzoin phenyl ether; alkylbenzoins, such as methylbenzoin, ethylbenzoin, propylbenzoin, butylbenzoin and pentylbenzoin; benzyl derivatives, such as benzyl-dimethylketal; 2,4,5-triaryl-imidazole dimers, such as 2-(o-chlorophenyl)-4,5-diphenylimidazole dimer, 2-(o-chloro-phenyl)-4,5-di(m-methoxyphenyl)imidazole dimer, 2-(o-fluorophenyl)-4,5-phenyl-imidazole dimer, 2-(o-methoxyphenyl)-4,5-diphenyl-imidazole dimer,2-(p-methoxy-phenyl)-4,5-diphenylimidazole dimer, 2,4-di(p-methoxy-phenyl)-5-phenyl-imidazole dimer and 2-(2,4-dimethoxyphenyl)-4,5-diphenyl-imidazole dimer; acridine derivatives such as 9-phenylacridine and 1,7-bis(9,9′-aridinyl)heptane; N-phenylglycine; benzophenones, anthraquinones, thioxanthones and derivatives thereof, including chloro-benzophenone, 4-phenylbenzophenone, trimethyl-benzophenone, 3,3′-dimethyl-4-methoxybenzophenone, 4,4′-dimethylamino-benzophenone, 4,4′-bis(diethyl-amino)-benzophenone, acrylated benzophenone, methyl-o-benzoyl benzoate, isopropyl-thioxanthone, 2-chloro and 2-ethyl-thioxanthone, 2-benzyl-2-(dimethyl-amino)-4′-morpholino-butyrophenone and hydroxy benzophenone; acetophenone derivatives including 2,2-dimethoxy-2-phenyl-acetophenone, 2,2-diethoxyacetophenone, 2,2-dimethoxy-2-phenylacetophene and 1-hydroxycyclohexylacetophenone; 2-hydroxy-2-methyl-1-phenylpropanone; 4-benzoyl-4′-methyl-diphenyl sulfide; ethyl 4-dimethyl-amino-benzoate; 2-ethyl-hydroquinone; (2,4,6-trimethylbenzoyl)diphenyl phosphine oxide (Lucerin TPO, available from BASF, Munich, Germany); ethyl(2,4,6-trimethyl-benzoyl-phenyl phosphinate; α-hydroxy ketone photoinitiators, such as 1-hydroxy-cyclohexyl-phenyl ketone (e.g., Irgacure® 184 available from Ciba Specialty Chemical (Hawthorne, N.Y.), 2-hydroxy-2-methyl-1-phenylpropanone, 2-hydroxy-2-methyl-1-(4-isopropyl-phenyl)propanone, 2-hydroxy-2-methyl-1-(4-dodecylphenyl)propanone, 2-hydroxy-2-methyl-1-phenylpropanone and 2-hydroxy-2-methyl-1-[(2-hydroxyethoxy)-phenyl]-propanone; (2,6-dimethoxy-benzoyl)-2,4,4-trimethylpentyl phosphine oxide (e.g., commercial blends Irgacure® 1800, 1850, and 1700 available from Ciba Specialty Chemical); 2,2-dimethoxyl-2-phenyl acetophenone (e.g., Irgacure® 651, available from Ciba Specialty Chemical); bisacylphosphine oxide photoinitiators, such as bis(2,4,6-trimethylbenzoyl)phenyl-phosphine oxide (e.g., Irgacure® 819 from Ciba Specialty Chemical), bis(2,6-dimethoxybenzoyl)-isooctyl-phosphine oxide and ethoxy (2,4,6-trimethyl-benzoyl)phenyl phosphine oxide (Lucerin® TPO-L from BASF), and combinations thereof.

The amount of photoinitiator present in the ink or coating composition generally is between 1 wt % to 30 wt %, and in some instances is 25 wt % or less, or 20 wt % or less, or 15 wt % or less, based on the weight of the composition. In some applications, the amount of photoinitiator present in the ink or coating composition is 10 wt % or less, or 5 wt % or less, based on the weight of the composition. In some applications, the amount of photoinitiator present in the ink or coating is 0.1%, 0.2 wt %, 0.3 wt %, 0.4 wt %, 0.5 wt %, 0.6 wt %, 0.7 wt %, 0.8 wt %, 0.9 wt %, 1 wt %, 1.25 wt %, 1.5 wt %, 1.75 wt %, 2 wt %, 2.25 wt %, 2.5 wt %, 2.75 wt %, 3 wt %, 3.25 wt %, 3.5 wt %, 3.75 wt %, 4 wt %, 4.25 wt %, 4.5 wt %, 4.75 wt %, 5%, 5.25 wt %, 5.5%, 5.75 wt %, 6 wt %, 6.25 wt %, 6.5 wt %, 6.75 wt %, 7 wt %, 7.25 wt %, 7.5 wt %, 7.75 wt %, 8 wt %, 8.25 wt %, 8.5 wt %, 8.75 wt %, 9 wt %, 9.25 wt %, 9.5 wt %, 9.75 wt %, 10 wt %, 11 wt %, 11.25 wt %, 11.5 wt %, 11.75 wt %, 12 wt %, 12.25 wt %, 12.5 wt %, 12.75 wt %, 13 wt %, 13.25 wt %, 13.5 wt %, 13.75 wt %, 14 wt %, 14.25 wt %, 14.5 wt %, 14.75 wt %, 15%, 15.25 wt %, 15.5%, 15.75 wt %, 16 wt %, 16.25 wt %, 16.5 wt %, 16.75 wt %, 17 wt %, 17.25 wt %, 17.5 wt %, 17.75 wt %, 18 wt %, 18.25 wt %, 18.5 wt %, 18.75 wt %, 19 wt %, 19.25 wt %, 19.5 wt %, 19.75 wt % or 20 wt %, based on the weight of the composition.

### D. Other Additives

The energy curable inks and coatings provided herein can include any material suitable for use in energy curable inks. The UV curable inks and coatings of the present invention can contain additives, alone or in combination, including conventional resins, oil, talc, pigment dispersant, gelled vehicles, soft inert resins, such as polyvinylethyl ethers and poly(n-butyl)acrylate, protonic or acidic adhesion promoters, ammonia, defoamers, stabilizers, silicones, inhibitors, viscosity modifiers, plasticizers, lubricants, wetting agents and waxes. Each of these additives separately can be used in an ink or coating provided herein at a level of from about 0.001% to about 20% or more based on the weight of the ink composition. If present, the amount of inhibitor usually is not more the 1.5 wt %.

1. Acidic or Amine Modified Adhesion Promoters

In some applications, the ink or coating composition includes one or more adhesion promoters. In some instances, the adhesion promoter contains one or more acrylate groups. The adhesion promoter can be an acidic modified adhesion promoter or an amine modified adhesion promoter. Exemplary acidic modified adhesion promoters include acidic acrylate oligomer, acrylic acid, polyester acrylate oligomer, β-carboxyethyl acrylate and acid functional acrylic resins, such as Joncryl® 678 acid functional acrylic resin (BASF Resins, Heerenveen, The Netherlands). A preferred acidic modified adhesion promoter is Sartomer CN 147, which is an acidic acrylate oligomer. Exemplary amine modified adhesion promoters include amine modified polyether acrylate oligomer (e.g., Laromer® PO 94 F (BASF Corp.) and EB 80 (Cytec Surface Specialties)), amine modified polyester tetraacrylate (e.g., EB81 (Cytec Surface Specialties)), and amine modified epoxy acrylate. If present, the amount of adhesion promoter generally is present in an amount of from 0.05 wt % to 15 wt %, and often is present in an amount of from 1 wt % to 10 wt %, based on the weight of the composition.

2. Waxes

In some applications, the ink or coating composition includes one or more waxes. Exemplary waxes that can be included in the printing inks and coatings provided herein include an amide wax, erucamide wax, polypropylene wax, paraffin wax, polyethylene wax, polytetrafluoroethylene (Teflon®) and carnuba wax and combinations thereof. A preferred wax is a blend of amide and erucamide waxes. The wax, if present, preferably is in an amount of up to about 4 wt %. It is preferred that, when a wax is present, it is present in an amount from about 0.01 wt.% to about 2 wt %.

### E. Viscosity

The amount and/or combination of monomer and oligomer in the ink or coating composition can be selected to provide a target viscosity. Other additives, such as a viscosity modifier, also can be included to adjust the viscosity of the ink or coating composition. The target viscosity of the ink or coating composition can vary depending on the type of process that is to be used to apply the ink or coating. The viscosity ranges for the various forms of non-contact deposition, including but not limited to, continuous and drop-on-demand ink jet, and for suitable forms of contact deposition, including, but not limited to, gravure and lithographic printing and flexography, are well known to those skilled in the art of printing. For example, see The Printing Ink Manual (5th ed., Leach et al. eds. (2009), pages 549-551 and 554-555 for flexographic printing; pages 485-489 for gravure printing; pages 682, 683, 696 and 697 for inkjet printing; pages 348 and 381 for lithographic printing).

For example, inks and coatings used with lithographic (e.g., offset) printing typically need to have a viscosity of at least at or about 4,500 cP (AR1000 Rheometer from TA Instruments, New Castle, Del. at 25° C. and a shear rate of 100 sec⁻¹), and the viscosity can be in the range of 5,000 cP to 15,000 cP, and in some applications, can have a viscosity in the range of 6,000 cP to 12,000 cP, and in some applications, can have a viscosity of at least about 10,000 cP, or at least about 14,000 cP. Inks and coatings formulated for flexographic printing generally have a lower viscosity, typically a viscosity of less than at or about 2,000 cP, and in some applications can be formulated to have a viscosity of less than at or about 1,000 cP or less than at or about 500 cP. Application viscosity for some flexographic inks can be between 35 and 200 cp. Inks formulated for gravure printing generally are formulated to have a viscosity between 15 and 25 seconds (Zahn Cup No. 2 at 25° C.).

### F. Ink and Coating Composition Preparation

The inventive inks and coatings provided herein can be prepared using any technique known in the art for preparation of inks and coatings. For example, ink bases can be prepared by mixing a pigment with a liquid mixture of resins (including grinding resins and adhesion promoting resins), monomers, oligomers or a combination of monomers and oligomers. Each base can be milled, such as by passing over a 3-roll mill, until a desired grind gauge specification is achieved. Once the desired grind is achieved, the base composition can be let down using let down varnishes that include a mixture of resins and optionally photoinitiators, and the let down material can be mixed until homogenous. In the case of the white inks, and generally for coatings, milling may not be necessary. The components of these inks and coatings generally are mixed using a high speed stirrer to obtain the final composition.

### IV. METHODS FOR MEASURING/QUANTIFYING [C═C]

Also provided herein are methods to measure and quantify the relative concentration of acrylate group for different acrylate raw materials, such as monomers and oligomers, in an ink or coating composition. Also provided are methods of calculating and optimizing the total concentration of acrylate group in the whole formula of an ink or coating composition. Using these methods, ink and coating compositions with extremely high [C═C], such as a relative acrylate group concentration >4.0, can be prepared. Such compositions exhibit increased adhesion to flexible substrates, including non-chemically treated films.

The inventive energy curable inks and coatings provided herein exhibit much better adhesion to substrates at a faster line speed than traditional energy curable inks, as well as improved MEK rub resistance. Exemplary substrates include coated or non-coated high density polyethylene (HDPE), low-density polyethylene (LDPE), medium-density polyethylene (MDPE), biaxially-oriented polypropylenes ((BO)PPs), polyvinyl chlorides (PVCs), glycol-modified polyethylene terephthalates (PET(G)s), paper and board substrates, as well as any other substrates utilized in lithographic and/or flexographic printing and/or other printing technology.

### A. Relative Acrylate Group Concentration

The inventive inks and coatings were formulated using relative raw material acrylate group concentration data. Typically, the absolute acrylate group concentration is regarded as confidential and often not disclosed by suppliers of component ingredients. Provided herein are methods to determine relative acrylate group concentration of component ingredients as well as the relative acrylate group concentration of the ink or coating composition. In exemplary methods, relative acrylate group concentration can be measured by attenuated total reflectance Fourier transform infrared spectroscopy (FTIR-ATR).

1. Measurement of Raw Material Acrylate Group Concentration (Method 1A)

The methods provided herein utilize methods of measuring the amount of acrylate group in a material or a complete formulation. Any method known in the art can be used to measure the amount of acrylate groups in a material or in the complete formulation. Exemplary methods include spectrographic methods, including IR and FTIR and ATR-FTIR, mass spectrometry and GC-MS. Preferred methods utilize the FTIR spectrums of acrylated materials. For example, FTIR spectrums of acrylated materials can be measured using a Magna-IR™ spectrometer 550 together with a Golden Gate diamond crystal attenuated total reflectance (ATR) unit. Multiple scans can be co-added. When FTIR measuring techniques are used, any peak characteristic of acrylate groups can be used to quantify the acrylate group concentration. Exemplary peaks include 810 cm⁻¹ and 1635 cm⁻¹. In an exemplary method, the area of the peak was chosen at 810 cm⁻¹ to quantify the acrylate group concentration using FTIR ATR, and 823±3 cm⁻¹ was chosen as the left boundary to measure the peak area and 791±3 cm⁻¹ was chosen as the right boundary. For inert resins that do not contain any reactive group, the acrylate group concentration is 0.

2. Mathematic Calculation of Acrylic Density of Ink or Coating (Method 1B)

The relative acrylate group concentration of the finished ink or color base also can be calculated using a simple mathematical equation. This can be done by converting the non-pigment components in the formula to 100 parts, and then multiplying the [C═C] value (determined using Test Method 1A above) of each component by the %, and finally adding all of the values together.

An example of this test method is shown below for an ink base and a finished ink. Pigment components of an ink base were 50% of the formulation, as shown in Table 2.

TABLE 2
UV Flexographic Cyan Ink Base.

| | | | [C═C] | [C═C] |
|---|---|---|---|---|
| Material | Parts | % | (Test Method 1A) | calculated |
| TMPTA | 48.9 | 97.8 | 6.3 | 6.16 |
| BYK A535 | 0.1 | 0.2 | 0 | 0 |
| (BYK USA Inc.) | | | | |
| Genorad ™ 16 | 1.0 | 2.0 | 0 | 0 |
| (Rahn USA Corp.) | | | | |
| Total | 50.00 | 100.00 | — | 6.16 |

After the pigment components are excluded, the resulting formula is 50% non-pigment. The non-pigment components are converted to a 100% composition (in this example by multiplying by a factor of 2). Neither BYK A535 (a defoamer from BYK USA Inc., Wallingford, Conn.) nor Genorad™ 16 (a polymerization inhibitor from Rahn USA Corp.) includes acrylate groups. TMPTA has a [C═C] of 6.3, determined using the FTIR-AFT method described above (Test Method 1A). By multiplying the amount of TMPTA in the non-ink components of the composition (97.8%) by the [C═C] of the TMPTA (6.3), yields a calculated [C═C] of 6.16 (6.3×0.978=6.16).

The relative acrylate group concentration of a finished ink similarly can be calculated mathematically. An exemplary formulation is shown Table 3 below:

TABLE 3
Finished UV Flexographic Cyan Ink formulation.

| | | | [C═C] | [C═C] |
|---|---|---|---|---|
| Material | Parts | % | (Test Method 1A) | calculated |
| Ink Base (above) | 25.0 | 25.0 | 6.16 | 1.54 |
| TMPTA | 35.0 | 35.0 | 6.3 | 2.21 |
| CN 147 (Sartomer) | 8.0 | 8.0 | 4.5 | 0.36 |
| Photoinitiator | 12.0 | 12.0 | 0 | 0 |
| DPHA (Cytec) | 10.0 | 10.0 | 7.5 | 0.75 |
| Ebecryl 871 (Cytec) | 10.0 | 10.0 | 3.88 | 0.39 |
| Total | 100.00 | 100.00 | — | 5.25 |

The components of the ink are converted from parts to percent, and the [C═C] of each component (such as obtained using the FTIR-AFT method described above in 1A) is multiplied by the percentage of the component in the composition, and each of the calculated [C═C] values is added to yield the total [C═C] of the composition.

3. Direct Measurement of Acrylic Density of Pigmented Ink (Method 1C)

The [C═C] of the ink or varnish or coating also can be measured directly by any method that can separate and distinguish acrylate groups in a composition. Exemplary methods include spectrographic methods, including IR and FTIR and ATR-FTIR, mass spectrometry and GC-MS. Preferred methods utilize the FTIR spectrums of acrylated materials. For example, FTIR spectrums of acrylated materials can be measured using a Magna-IR™ spectrometer 550 together with a Golden Gate diamond crystal attenuated total reflectance (ATR) unit. For finished inks, the varnishes can be separated from pigment and other dry additives using the following procedure.

### Varnish Separation Procedure:

1. Ethyl acetate is used to dissolve the ink.
2. The solution is centrifuged to deposit pigments and other dry additives to the bottom of the centrifuge tube.
3. The upper transparent solution is removed and transferred to a flat pan.
4. All solvent in the upper solution now in the flat pan is evaporated in a 60° C. oven for an hour.
5. The residue, containing ink varnish, is collected for FTIR-ATR measurement.

It was found that the calculated result matches the instrument measured result closely (e.g., see Table 8 of Examples 4-6). In a preferred embodiment, the ink varnish has a relative acrylic group concentration above 4.0 using the characterization described above. In more preferred embodiments, a relative acrylate group concentration above 4.5 or above 5.0 would be preferable, especially in the case of opaque inks and high opacity inks.

### V. TEST PROTOCOLS

### A. Adhesion Test

3M™ 600 film tape is used to test adhesion. A fast peel test was performed right after cure of the ink or coating on the substrate. The film tape is adhered to the printed cured ink sample on the substrate and then removed by hand at a fast rate in one continuous motion. Adhesion is reported on a scale of 0-10, where 0 is worst and 10 is best. The 0-10 scale is based on the approximate amount of ink remaining on the substrate after the peel test (i.e. 0=0% remaining ink, or conversely 100% peel off; 10=100% remaining ink, or conversely 0% peel off).

### B. Opacity

Opacity of the cured printed ink or coating composition on a substrate is measured using a BNL-2 opacimeter (Technidye Corporation, New Albany, Ind., USA). The ink or coating is deposited on a substrate and energy cured (for example, by exposure to UV light from a Hg UV lamp). Once cured, the opacity of the cured printed ink is measured. The BNL-2 opacimeter is calibrated using a proof of white ink of known opacity. A black body proof then is measured to verify the calibration (reading of 00.0 obtained). The printed sample is placed on a white body proof, the short dimension of the printed sample sheet is centered within the meter and a measurement is taken. Multiple measurements usually are taken and averaged (e.g., an average of 5 readings).

### C. MEK Rub Resistance

The ASTM D4756 test is used to measure MEK rub resistance. The test involves rubbing the surface of a cured film with a cotton pad soaked with MEK until failure or breakthrough of the film. The rubs are counted as a double rub (one rub forward and one rub backward constitutes one double rub). In the test, a cotton swab is dipped into MEK and double rubs were performed on the surface of the substrate coated with the ink until the coating began to break. A minimum of 10 rubs is required to be considered to be an acceptable rub resistance.

### D. Color Density

The color density of the cured printed inks can be measured using the SpectroEye color density instrument (from X-Rite, Incorporated, Grand Rapids Mich.) running X-Rite Color® Master software. Color density is measured using a paper white base under the printed sample and an observer angle of between 2° and 10° was selected. The SpectroEye is positioned on the area to be measured, ensuring that the measuring aperture of the SpectroEye is centered in the area in which the color density is to be measured, and the sample color density is measured.

### VI. EXAMPLES

The following examples, including experiments and results achieved, are provided for illustrative purposes only and are not to be construed as limiting the claimed subject matter.

All of the inventive ink bases in the examples were prepared by mixing a pigment with a liquid mixture of resins (including grinding resins and adhesion promoting resins), oligomers, and monomers (see formulas below). Each base was passed over a 3-roll mill until a grind gauge specification of 3/2 was achieved (measured on a National Printing Ink Research Institute (NPIRI) G-1 grind gauge). Each base composition was then let down using let down varnishes comprising a mixture of resins and photoinitiators and mixed until homogenous. In the case of the white inks, Examples 1A, 1B, 1C and 2, a 3-roll mill was not necessary. These inks were mixed using a high speed stirrer to obtain the specified grind.

All inks were printed on non-corona treated, non-chemically treated transparent and white HDPE films using a Harper Junior Hand proofer. Different anilox were chosen for different colors to achieve different color density/opacity targets (see Table 4 below). All prints made with inventive inks and comparative commercial inks in the examples were cured through 200 watt Hg UV lamp at a speed of 150 fpm.

TABLE 4
Anilox rollers used for various finished ink colors.

| Ink Color | Anilox Roller | ²Opacity/³Color Density |
|---|---|---|
| White | 4 bcm¹ 360 line anilox | Opacity varies (see examples) |
| Black | 4 bcm 360 line anilox | color density 1.8-2.0 |
| Yellow | 2 bcm 800 line anilox | color density 1.0-1.1 |
| Magenta | 2 bcm 800 line anilox | color density 1.2-1.3 |
| Cyan | 2 bcm 800 line anilox | color density 1.6-1.7 |

¹bcm = billion cubic microns per square inch.
²Opacity was measured using a BNL-2 opacimeter.
³Color density was measured using an X-Rite SpectroEye color density instrument running X-Rite Color ®Master.

### Examples 1A-1C

UV flexographic white ink compositions having varying relative acrylate group concentration were prepared. The difference in the three samples (1A, 1B and 1C) is that 5% of the formula was varied, using monomers or oligomers with different acrylate group concentrations. Inks were printed to opacity 48-50 and cured using a standard 200 watt H mercury lamp at 150 FPM. Table 5 below shows the composition of these UV flexographic white inks (Examples 1A-1C), the ink varnish acrylate group concentration, and the 3M™ 600 tape adhesion results of the cured ink on the substrate.

TABLE 5
Composition of Examples 1A, 1B, 1C - UV Flexo White Inks.

| Material | Type | ¹[C═C] | Ex. 1A | Ex. 1B | Ex. 1C |
|---|---|---|---|---|---|
| TMPTA | Monomer | 6.3 | 30 | 30 | 30 |
| BYK 9077 | Dispersant | 0 | 2 | 2 | 2 |
| (BYK USA Inc.) | | | | | |
| Kronos 2310 | TiO₂ | 0 | 50 | 50 | 50 |
| (Kronos) | Pigment | | | | |
| Genorad ™ 16 | Inhibitor | 0 | 0.3 | 0.3 | 0.3 |
| (Rahn USA Corp.) | | | | | |
| ²Photoinitiator | Initiator | 0 | 10 | 10 | 10 |
| HDDA | Monomer | 4.9 | 5 | — | — |
| TMPTA | Monomer | 6.3 | — | 5 | — |
| DPHA | Oligomer | 7.5 | — | — | 5 |
| Total | | | 97.3 | 97.3 | 97.3 |
| ³Opacity | — | — | 48-49 | 48-49 | 48-49.8 |
| ⁴[C═C] | — | — | 4.51 | 4.66 | 4.79 |
| 3M ™ 600 Tape test | — | — | 2 | 8-9 | 9-10 |
| MEK Resistance | — | — | <10 | 10-15 | 10-15 |

¹Measured relative acrylate group concentration [C═C] obtained using Test Method 1A
²Photoinitiator blend = IGM73(50%), IGM TPO (50%) (both available from IGM Resins)
³Opacity obtained using Test Method 3
⁴Relative acrylate group concentration [C═C] obtained using Test Method 1B

By using monomers or oligomers with higher relative acrylate group concentration, the relative acrylate group concentration of the finished ink is raised and the tape adhesion and MEK rub resistance are improved significantly. As demonstrated by the data shown in the Table above, as the acrylate group concentration [C═C] is raised, the adhesion and rub resistance properties improve.

### B. Example 2

### High Opacity UV Flexo White Ink

In this Example, UV flexographic white ink compositions were printed at high opacity on a substrate. When printed at an increased opacity of 50-55, each of the Example 1A, 1B and 1C inks exhibited decreased adhesion, as exhibited by poor tape adhesion values.

In order to achieve good adhesion at higher opacity (>50), inventive Example 2 opaque UV flexo white was formulated. Example 2 ink is very similar to the ink of Example 1C, but is higher opacity (>55) and further contains 5% Sartomer CN 147 and increased DPHA (11.3%) to raise the relative acrylic group concentration to 5.22. The formulation is shown in Table 6 below.

TABLE 6
High Opacity UV Flexo White Ink Formulation.

| Material | Type | ¹[C═C] | Ex. 2 |
|---|---|---|---|
| TMPTA | Monomer | 6.3 | 13.7 |
| BYK 9077 (BYK USA Inc.) | Dispersant | 0 | 2 |
| Kronos 2310 (Kronos Inc. USA) | TiO₂ Pigment | 0 | 50 |
| Genorad ™ 16 (Rahn USA Corp.) | Inhibitor | 0 | 0.3 |
| ²Photoinitiator | Initiator | 0 | 10 |
| HDDA | Monomer | 4.9 | 5 |
| TMPTA | Monomer | 6.3 | — |
| DPHA | Oligomer | 7.5 | 11.3 |
| CN 147 (Sartomer) | Adhesion | 4.5 | 5 |
| | Promoter | | |
| Total | | | 97.3 |
| Opacity | — | — | >55 |
| ³[C═C] | — | — | 5.22 |
| 3M ™ 600 Tape test | — | — | 10 |

¹Measured relative acrylate group concentration [C═C] obtained using Test Method 1A
²Photoinitiator blend = IGM73(50%), IGM TPO (50%) (both available from IGM Resins)
³Relative acrylate group concentration [C═C] obtained using Test Method 1B

Under the same curing conditions using a standard 200 watt H mercury lamp at 150 FPM line speed, Example 2 white ink passed the tape adhesion test with 100% ink maintained on the substrate when printed to opacity above 55. Other commercially available UV flexo white inks, which have a relative acrylate group concentration of <4.0, failed the tape adhesion test, exhibiting 100% peel off (0% adhesion). This further demonstrates that increasing the acrylic group concentration as done in the inventive ink and coating compositions provided herein imparts improved adhesion to the inks and coatings.

### C. Example 3

### UV Flexographic Cyan Ink

1. Example 3A: UV Flexographic Cyan Base

Example 3A shows the composition of a UV flexographic cyan base as well as the measured acrylate group concentration of the constituent monomer and the calculated ink acrylate group concentration. The ink included 48.9% TMPTA, which has a relative acrylate group concentration of 6.3. As shown in Table 7, the UV flexographic cyan ink base had a relative acrylate group concentration of 6.16 as measured using Method 1B (described above).

TABLE 7
UV Flexographic Cyan Base Composition and [C═C].

| Material | Type | ¹[C═C] | Example 3A |
|---|---|---|---|
| Genorad ™ 16 (Rahn USA Corp.) | Inhibitor | 0 | 1 |
| TMPTA | Monomer | 6.3 | 48.9 |
| BYK A535 (BYK USA Inc.) | Defoamer | 0 | 0.1 |
| SPECTRAPAC ® C BLUE 15:4 | Pigment | 0 | 50 |
| Total | — | — | 100.0 |
| ²[C═C] | — | — | 6.16 |

¹Measured relative acrylate group concentration [C═C] obtained using Test Method 1A
²Relative acrylate group concentration [C═C] obtained using Test Method 1B
⁵Photoinitiator Blend = IGM 73 (23%), IGM ITX (28%), IGM EDB (28%), Irgacure ® 369 (14%), Irgacure ® 184 (3.5%), IGM TPO (3.5%)

### 2. Example 3B

### UV Flexographic Cyan Finished Ink

The cyan base prepared in Example 3A was used to prepare a UV flexographic cyan finished ink. The ink composition includes the cyan base of Example 3A, as well as acrylate group-containing monomers, acrylate group-containing oligomer and an acrylate group-containing adhesion promoter. The [C═C] values for each of the components is shown in Table 8. The relative acrylate group concentration for the cyan finished ink was 5.25.

TABLE 8
UV Flexographic Cyan Finished Ink Composition and [C═C].

| Material | Type | ¹[C═C] | Example 3B |
|---|---|---|---|
| Example 3A | Base | 6.16 | 25 |
| TMPTA | Monomer | 6.3 | 35 |
| CN 147 (Sartomer) | Adhesion Promoter | 4.5 | 8 |
| Photoinitiator² | Photoinitiator Blend | 0 | 12 |
| DPHA | Oligomer | 7.5 | 10 |
| Ebecryl 871(Cytec) | Oligomer | 3.88 | 10 |
| Total | — | — | 100 |
| ³[C═C] | — | — | 5.25 |

¹Measured relative acrylate group concentration [C═C] obtained using Test Method 1A
²Photoinitiator Blend = IGM 73 (23%), IGM ITX (28%), IGM EDB (28%), Irgacure ® 369 (14%), Irgacure ® 184 (3.5%), IGM TPO (3.5%)
³Relative acrylate group concentration [C═C] obtained using Test Method 1B

### D. Examples 4-6

### UV Flexo Yellow, Magenta and Black Inks

Formulations were made based on the materials used in Example 3. In each case, the cyan pigment of Example was replaced as follows: Example 4 contains yellow pigment to provide a UV flexo yellow; Example 5 contains magenta pigment to provide a UV flexo magenta; and Example 6 contains carbon black pigment to provide a UV flexo black.

1. Comparison of Acrylate Group Concentration Measurement

Measured acrylate group concentration (using Method 1A) and calculated acrylate group concentration (using Method 1B) for each of the inks of Examples 2 through 6 is shown in Table 9. Table 9 also provides data showing the difference between the calculated acrylate group concentration of the ink varnishes and finished inks, and the measured result after the ink varnish is separated from pigment and dry additives. As can be seen from the data, the difference between the two values is less than 5%.

TABLE 9
[C═C] of Inventive ink varnishes - calculated vs. measured.

| | Measured | Calculated | % |
|---|---|---|---|
| Example | Result ¹[C═C] | Result ²[C═C] | Difference |
| Example 2 | 5.09 | 5.22 | 2.55 |
| Example 3B | 5.17 | 5.25 | 1.55 |
| Example 4 | 5.03 | 5.12 | 1.78 |
| Example 5 | 4.57 | 4.57 | 0 |
| Example 6 | 5.45 | 5.40 | 0.91 |

¹Measured relative acrylate group concentration [C═C] obtained using Test Method 1A
²Relative acrylate group concentration [C═C] obtained using Test Method 1B

2. Adhesion Testing

Printed and cured inks of Examples 2 through 6 were tested for adhesion using the tape adhesion test. The inks were printed on non-corona treated, non-chemically treated white HDPE film using a Harper Junior Hand proofer. The inks were cured using a 200 watt Hg UV lamp at a line speed of 150 fpm. A fast peel test was performed right after cure of the ink or coating on the substrate. 3M™ 600 film tape was used to test adhesion.

Table 10 provides data showing that the inventive inks (Examples 2, 3B and 4-6) all passed the tape test with 0% ink peel off. Prior art comparative commercial inks (Table 11) printed on the same substrate and cured using the same conditions failed the tape adhesion testing, exhibiting 100% ink peel off (0% adhesion).

TABLE 10
Adhesion Test Results of Inventive Inks.

| Example | ¹[C═C] of ink varnish | 600 Tape test |
|---|---|---|
| Example 2 | 5.22 | 10 |
| Example 3B | 5.25 | 10 |
| Example 4 | 5.12 | 10 |
| Example 5 | 4.57 | 10 |
| Example 6 | 5.40 | 10 |

¹Relative acrylate group concentration [C═C] obtained using Test Method 1B

TABLE 11
Adhesion Test Results of Comparative
Inks (all from Sun Chemical).

| | ¹[C═C] of | 3M ™ 600 |
|---|---|---|
| Commercial Comparative Ink | ink varnish | Tape test |
| DFR9006 DEV UV flexo first down white | 3.01 | 0 |
| Suncure FR Max white | 2.9 | 0 |
| SF-36004 silicone free opaque whit | 3.5 | 0 |
| Trinity black | 3.76 | 0 |
| Suncure FR Max D black | 3.86 | 0 |
| Trinity Cyan | 3.85 | 0 |
| UV flexo FR blue | 3.41 | 0 |
| (SEP cyan FLNFV5482107) | | |
| UV flexo FR red | 3.77 | 0 |
| (SEP magenta(FLNFV4482106) | | |

¹Relative acrylate group concentration [C═C] obtained using Test Method 1B

3. Lab Press Trials

In addition to ink trials using a Harper Junior Hand proofer, a press trial was performed by deposition of the inventive and comparative inks on non-corona treated, non-chemically treated white HDPE film at an advanced line speed of 240 feet per minute (fpm) under irradiance from a 300 watt Hg lamp. All of the inventive inks maintained tape adhesion with no ink peel off (100% adhesion) while all of the comparative inks exhibited 100% ink peel off (0% adhesion).

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicant's general inventive concept. Since modifications will be apparent to those of skill in this art, it is intended that this invention be limited only by the scope of the following claims.

1. An energy curable printing ink or coating composition, comprising a monomer containing an acrylate group or oligomer containing an acrylate group or a combination thereof, wherein the composition has a relative acrylate group concentration >4.0.

2. The energy curable printing ink or coating composition of claim 1, wherein the monomer is selected from among propoxylated neopentyl glycol diacrylate (2PO-NPGDA), 1,6-hexanediol diacrylate (HDODA), hexanediol diacrylate (HDDA), dipentaerythritol hexaacrylate (DPHA), ethoxylated hexanediol diacrylate (EOHDDA), trimethylolpropane triacrylate (TMPTA), ethoxylated trimethylolpropane triacrylate (EOTMPTA), dipropylene glycol diacrylate (DPGDA) and combinations thereof.

3. The energy curable printing ink or coating composition of claim 1, wherein the oligomer is selected from among an acidic acrylate, epoxy acrylate, polyester acrylate, ethoxylated acrylate, unsaturated polyester, polyamide acrylate, polyimide acrylate and urethane acrylate and combinations thereof.

4. The energy curable printing ink or coating composition of claim 1, further comprising an acidic or amine modified adhesion promoter.

5. The energy curable printing ink or coating composition of claim 1, further comprising a pigment or dye or a combination thereof.

6. The energy curable printing ink or coating composition of claim 1, further comprising a material selected from among a photoinitiator, resin, oil, talc, pigment dispersant, gelled vehicle, a polyvinylethyl ether and poly(n-butyl)acrylate, a wax, ammonia, a defoamer, a stabilizer, a silicone and a plasticizer and combinations thereof.

7. The energy curable printing ink or coating composition of claim 1, wherein the monomer is present in an amount of up to 75 wt % based on the weight of the composition.

8. The energy curable printing ink or coating composition of claim 1, wherein the oligomer is present in an amount of up to 50 wt % based on the weight of the composition.

9. The energy curable printing ink or coating composition of claim 1, wherein the relative acrylate group concentration is >4.25.

10. The energy curable printing ink or coating composition of claim 1, wherein the relative acrylate group concentration is >4.5.

11. The energy curable printing ink or coating composition of claim 1, wherein the relative acrylate group concentration is >4.75.

12. The energy curable printing ink or coating composition of claim 1, wherein the relative acrylate group concentration is >5.0.

13. The energy curable printing ink or coating composition of claim 1, wherein the relative acrylate group concentration is >5.25.

14. The energy curable printing ink or coating composition of claim 1, wherein the relative acrylate group concentration is >5.5

15. The energy curable printing ink or coating composition of claim 1, wherein the composition includes monomer and oligomer and the ratio of momomer:oligomer is from X:Y, wherein X is selected from among 0.1 to 100 and Y is selected from among 0.1 to 10.

16. The energy curable printing ink or coating composition of claim 1, wherein the viscosity of the ink or coating is 2,000 cP or less when measured at 25° C. at a shear rate of 100 sec⁻¹.

17. A method of formulating an energy curable printing ink or coating composition, comprising:
selecting a monomer containing an acrylate group or oligomer containing an acrylate group or a combination thereof; and
incorporating the monomer or oligomer or combination thereof in an amount to yield an ink or coating composition having a relative acrylate group concentration >4.0.

18. The method of claim 17, wherein the relative acrylate group concentration is >4.25.

19. The method of claim 17, wherein the relative acrylate group concentration is >4.5.

20. The method of claim 17, wherein the relative acrylate group concentration is >4.75.

21. The method of claim 17, wherein the relative acrylate group concentration is >5.00.

22. The method of claim 17, wherein the relative acrylate group concentration is >5.25.

23. The method of claim 17, wherein the relative acrylate group concentration is >5.50.

24. The method of claim 17, wherein the ink or coating is formulated to have a viscosity suitable for deposition by a process selected from the group consisting of flexographic, gravure, roller coating, cascade coating, curtain coating, slot coating, wire bound bar and digital.

25. The method of claim 24, wherein the deposition process is flexographic.

26. The method of claim 24, wherein the ink or coating is curable by any one of UV, LED, H-UV and EB radiation or a combination thereof.

27. The method of claim 25, wherein the ink or coating is curable by UV radiation.

28. The method of claim 17, wherein the viscosity of the ink or coating is 2,000 cP or less when measured at 25° C. at a shear rate of 100 sec⁻¹.

29. A printed article comprising a cured ink or coating of claim 1.
